(19) United States
(12) Patent Application Publication
(10) Pub. No.: US 2021/0167809 A1
(43) Pub. Date: Jun. 3, 2021

(54) MOBILE TERMINAL HAVING SHARED RADIO FREQUENCY ANTENNA

(71) Applicant: JRD Communication (Shenzhen) LTD., Shenzhen City (CN)

(72) Inventors: Jianhua XU, Shenzhen City (CN); Fan HUANG, Shenzhen City (CN)

(73) Assignee: JRD Communication (Shenzhen) LTD., Shenzhen City (CN)

(21) Appl. No.: 16/641,656

(22) PCT Filed: Aug. 24, 2018
(86) PCT No.: PCT/CN2018/102348

§ 371 Date: Feb. 25, 2020

(30) Foreign Application Priority Data
Aug. 25, 2017 (CN) 201710741183.6

(51) Int. Cl. H04B 1/40; H01Q 1/24

(52) U.S. Cl. CPC H04B 1/40; H01Q 1/243

(57) ABSTRACT

The present application discloses a mobile terminal having a shared radio frequency antenna, comprising a PCB; the PCB is provided thereon with a distance sensing module, a radio frequency module, a filtering module for preventing a signal, that is not needed by the operation of the distance sensing module, from passing, and a radio frequency antenna module for generating a resonance frequency that is needed by the operation of the distance sensing module and a resonance frequency that is needed by the operation of the radio frequency module; the distance sensing module is connected to the radio frequency antenna module by means of the filtering module; and the radio frequency antenna module is further connected to the radio frequency module.

### CROSS REFERENCE

This application claims the priority of Chinese Patent Application No. 201710741183.6, entitled “MOBILE TERMINAL HAVING SHARED RADIO FREQUENCY ANTENNA”, filed on Aug. 25, 2017 in the CNIPA (National Intellectual Property Administration, PRC), the disclosure of which is incorporated herein by reference in its entirety.

### FIELD OF THE INVENTION

The present invention relates to an antenna design for a mobile terminal having a distance sensing function, and more particularly, to a mobile terminal with a share radio frequency (RF) antenna.

### BACKGROUND OF THE INVENTION

As the progress of the communication technology, mobile terminals, such as a cell phone, have become necessary in human life. More and more cell phones are equipped with a distance sensing function.

The distance sensing function could reduce the radiation to human bodies and reduce the power consumption of the mobile terminal. When the user is getting closer to the mobile terminal, the transmission function of the antenna is reduced to reduce the radiation to a human body. Therefore, most of the mobile terminals are equipped with the distance sensing function.

The distance sensing chip and the RF chip in a conventional mobile terminal are independently connected to their antennas. As shown in FIG. 1, the distance sensing antenna is close to the RF antenna. Because both antenna are close to each other and are made by metal, they introduce interferences to each other. Furthermore, the occupied area of the distance sensing antenna is larger and the cost of the distance sensing antenna is higher.

Therefore, it needs to be improved.

### SUMMARY

One objective of an embodiment of the present invention is to provide a mobile terminal with a shared antenna to solve the above-mentioned issues of high interferences and high costs.

According to a first aspect of the present invention, a mobile terminal with a shared radio frequency (RF) antenna is disclosed. The mobile terminal comprises: a printed circuit board (PCB), comprising: a distance sensing module, configured to perform a distance sensing operation; a radio frequency (RF) module, configured to perform an RF transceiving operation; a filter module, configured to filter out a unwanted portion of an output signal of the distance sensing module; and an RF antenna module, electrically connected to the RF distance sensing module through the filter module and electrically connected to the RF module, configured to generate a resonant frequency for the distance sensing module and a resonant frequency for the RF module.

In the mobile terminal, the filter module comprises: a first resistor; a first capacitor; and a first inductor. One end of the first resistor is electrically connected to the RF antenna, and another end of the first resistor is electrically connected to a ground through the first capacitor and is electrically connected to the distance sensing module through the first inductor.

In the mobile terminal, the first inductor has an inductance between 39-100 nh.

In the mobile terminal, the RF antenna comprises: an RF antenna and a second resistor. An end of the RF antenna is electrically connected to the ground through the second resistor and is electrically connected to the end of the first resistor.

In the mobile terminal, the RF module comprises: an RF chip; a third resistor; a fourth resistor; and a second capacitor. An end of the third resistor is electrically connected to the end of the RF antenna, another end of the third resistor is electrically connected to the ground through the second capacitor and is electrically connected to a signal pin of the RF chip through the fourth resistor, and the GND pin of the RF chip is electrically connected to the ground.

In the mobile terminal, a model type of the RF chip is RF1662.

In the mobile terminal, the distance sensing module comprises: a distance sensing chip; a fifth resistor; a sixth resistor; and a third capacitor. One end of the fifth resistor is electrically connected to the another end of the first resistor through the first inductor, another end of the fifth resistor is electrically connected to the ground through the third capacitor and is electrically connected to an RX pin of the distance sensing chip through the sixth resistor, a GND pin of the distance sensing chip is electrically connected to the ground, and a VDD pin of the distance sensing chip is electrically connected to a 3.3V voltage source.

In the mobile terminal, a model type of the distance sensing chip is LDJ18829M24AC002.

In the mobile terminal, the first resistor is installed near the antenna feeding point and the first inductor is installed near the distance sensing chip.

According to a second aspect of the present invention, a mobile terminal with a shared radio frequency (RF) antenna is provided, the mobile terminal includes a printed circuit board (PCB). The PCB includes: a distance sensing module, configured to perform a distance sensing operation; a radio frequency (RF) module, configured to perform an RF transceiving operation; a filter module, configured to filter out a unwanted portion of an input signal of the distance sensing module; and an RF antenna module, electrically connected to the RF distance sensing module through the filter module and electrically connected to the RF module, configured to generate a resonant frequency for the distance sensing module and a resonant frequency for the RF module.

The RF antenna module generates a working signal when the mobile terminal is working in a communication mode, and the working signal is respectively transmitted to the RF module and the filter module; the RF module receives the working signal and works accordingly; and the filter module receives the working signal and filters out a high frequency portion from the working signal such that the distance sensing module and the RF module share an antenna to prevent from incorrectly triggering the distance sensing module and ensure that the distance sensing module is correctly triggered when the distance sensing operation is required.

In the mobile terminal, the filter module comprises: a first resistor; a first capacitor; and a first inductor. One end of the first resistor is electrically connected to the RF antenna, and another end of the first resistor is electrically connected to a ground through the first capacitor and is electrically connected to the distance sensing module through the first inductor.

In the mobile terminal, the first inductor has an inductance between 39-100 nh.

In the mobile terminal, the RF antenna comprises: an RF antenna and a second resistor. An end of the RF antenna is electrically connected to the ground through the second resistor and is electrically connected to the end of the first resistor.

In the mobile terminal, the RF module comprises: an RF chip; a third resistor; a fourth resistor; and a second capacitor. An end of the third resistor is electrically connected to the end of the RF antenna, another end of the third resistor is electrically connected to the ground through the second capacitor and is electrically connected to a signal pin of the RF chip through the fourth resistor, and the GND pin of the RF chip is electrically connected to the ground.

In the mobile terminal, a model type of the RF chip is RF1662.

In the mobile terminal, the distance sensing module comprises: a distance sensing chip; a fifth resistor; a sixth resistor; and a third capacitor. One end of the fifth resistor is electrically connected to the another end of the first resistor through the first inductor, another end of the fifth resistor is electrically connected to the ground through the third capacitor and is electrically connected to an RX pin of the distance sensing chip through the sixth resistor, a GND pin of the distance sensing chip is electrically connected to the ground, and a VDD pin of the distance sensing chip is electrically connected to a 3.3V voltage source.

In the mobile terminal, a model type of the distance sensing chip is LDJ18829M24AC002.

In the mobile terminal, the first resistor is installed near the antenna feeding point and the first inductor is installed near the distance sensing chip.

In the mobile terminal, the first resistor is installed near the antenna feeding point and the first inductor is installed near the distance sensing chip.

In the mobile terminal, the first capacitor is a filter capacitor for filtering out a signal portion having a frequency higher than 600 MHz.

In contrast to the conventional art, a mobile terminal with a shared radio frequency (RF) antenna is provided, the mobile terminal includes a printed circuit board (PCB). The PCB includes: a distance sensing module, configured to perform a distance sensing operation; a radio frequency (RF) module, configured to perform an RF transceiving operation; a filter module, configured to filter out a unwanted portion of an input signal of the distance sensing module; and an RF antenna module, electrically connected to the RF distance sensing module through the filter module and electrically connected to the RF module, configured to generate a resonant frequency for the distance sensing module and a resonant frequency for the RF module. The mobile terminal of an embodiment adopts the RF antenna module and the filter module respectively capable of generating high-frequency and low-frequency resonant frequencies. Therefore, when the distance sensing module and the RF module shares the same antenna, they do not influence each other. This reduces the number of antenna and solves the issues of the above-mentioned issues of high interferences due to the short distance between two antennas and the metallic material of the two antennas. Furthermore, it also reduces the cost.

### BRIEF DESCRIPTION OF THE DRAWINGS

FIG. 1 is a diagram of an antenna module of a mobile terminal according to the conventional art.

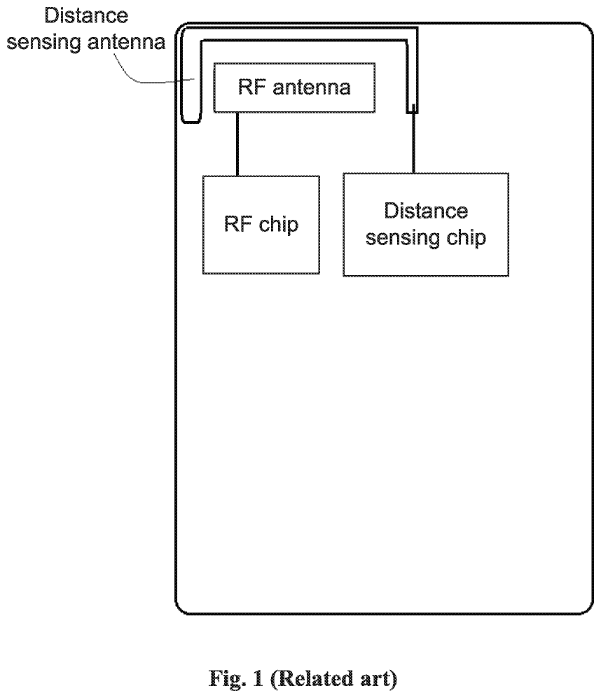

FIG. 2 is a diagram of a structure of a mobile terminal with a shared RF antenna according to an embodiment of the present invention.

FIG. 3 is a circuit diagram of the mobile terminal according to an embodiment of the present invention.

### DETAILED DESCRIPTION OF PREFERRED EMBODIMENTS

The invention is described below in detail with reference to the accompanying drawings, wherein like reference numerals are used to identify like elements illustrated in one or more of the figures thereof, and in which exemplary embodiments of the invention are shown. This invention may, however, be embodied in many different forms and should not be construed as limited to the particular embodiments set forth herein. Rather, these embodiments are provided so that this disclosure will be thorough and complete, and will fully convey the scope of the invention to those skilled in the art.

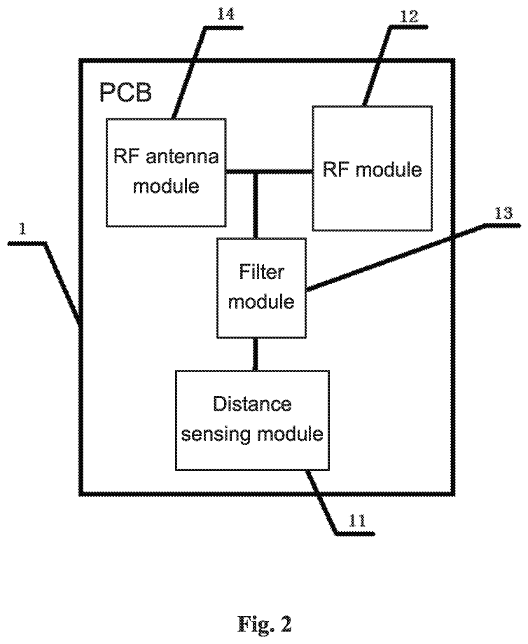

Please refer to FIG. 2. FIG. 2 is a diagram of a structure of a mobile terminal with a shared RF antenna according to an embodiment of the present invention. As shown in FIG. 2, the mobile terminal comprises a printed circuit board (PCB) 1. The PCB comprises a distance sensing module 11, an RF module 12, a filter module 13, and an RF antenna module 14. The distance sensing module 11 is electrically connected to the RF antenna module 14 through the filter module 13. The RF antenna module 14 is electrically connected to the RF module 12.

The RF antenna module 14 could generate a low-frequency resonant frequency (determined by the working frequency of the distance sensing module) and a high-frequency resonant frequency (corresponding to the working frequency of the RF module 12) such that the RF antenna module 14 could satisfy the demands of a low-frequency working signal required by the distance sensing module 11 and a high-frequency working signal required by the high-frequency RF module 12. The filter module 13 is used to block the unwanted portion of the input signal of the distance sensing module 11. While the mobile terminal is working in a communication mode, the RF antenna module 14 generates a working signal. The working signal is transmitted to the RF module 12 and the filter module 13. The RF module 12 receives the working signal and works accordingly. The filter module 13 receives the working signal and filters out the high-frequency portion of the working signal. For example, the filter module 13 could filter out the portion having frequency larger than 600 MHz and only allow the signal having the frequency lower than 500 MHz to pass through. The filtered working signal is then transmitted to the distance sensing module 11 as its input signal such that the distance sensing module 11 works accordingly. In this way, it could prevent the distance sensing module 11 from being incorrectly triggered. It could also ensure that the distance sensing module 11 could correctly be triggered when the distance sensing operation is required. The distance sensing module 11 is used to perform the distance sensing operation. The RF module 12 is used to perform a RF transceiving operation.

Furthermore, the mobile terminal could be a LTE, 3G or 2G wireless communication smart terminals having the distance sensing function, such as a tablet, a cell phone, a data card, etc. These belong to the scope of the present invention.

In this embodiment, the RF antenna module 14 and the filter module 13 capable of generating high-frequency and low-frequency resonant frequencies are adopted. This reduces the interferences between the distance sensing module 11 and the RF module 12 when they share the same antenna. Because only one shared antenna is used, the number of antennas is reduced and thus the cost is reduced. Furthermore, the above-mentioned issue of interferences is also solved.

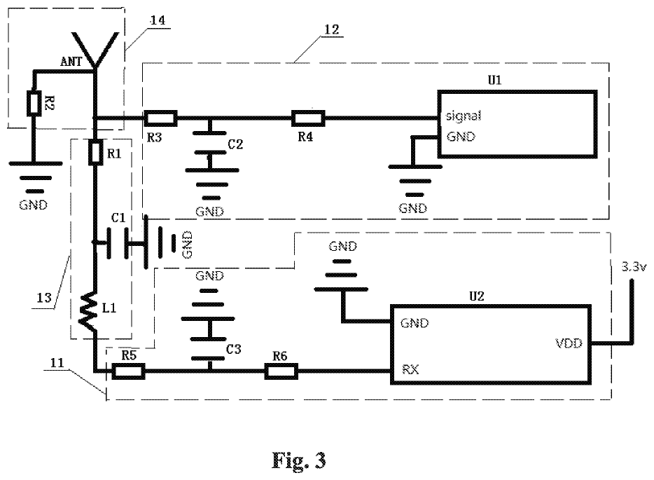

Please refer to FIG. 2 in conjunction with FIG. 3. In order to allow only the necessary working signal for the distance sensing module 11 (filter out the unwanted portion), the filter module comprises the first resistor R1, the first capacitor C1 and the first inductor L1. One end of the first resistor R1 is electrically connected to the RF antenna module 14 and the other end of the first resistor R1 is electrically connected to the ground through the first capacitor C1 and is also electrically connected to the distance sensing module 11 through the first inductor L1.

Specifically, the first resistor R1 connects the distance sensing module 11 to the RF antenna module 14 to realize the share of antenna. The first inductor L1 is used to block high-frequency portions and allow the low-frequency portion (such as signals having a frequency lower than 500 MHz) to pass through. The first capacitor C1 is a filter capacitor for filtering out signals having a frequency higher than 600 MHz. When the mobile terminal is working in the communication mode and the communication signals are inputted from the RF antenna module 14 into the distance sensing module 11, the communication signals are released to the ground through the first resistor R1 and the first capacitor and the high-frequency portion (higher than 600 MHz) of the communication signals are blocked by the first inductor L1 to prevent the distance sensing module from being incorrectly triggered. When the distance sensing module 11 needs to work, a low frequency signal is inputted the distance sensing module 11 through the first resistor R1 and the first inductor L1 to trigger the distance sensing module 11.

Through installing the filter module 13, when the mobile terminal is working in the communication mode, the communication signal is released to the ground and the signal having the frequency higher than 600 MHz is blocked. This prevents the distance sensing module from being incorrectly triggered. When the distance sensing module 11 needs to work, the filter module 13 could allow the low-frequency signal to pass through the filter module to trigger the distance sensing module 11 to work. In this way, there is no need to add another distance sensing antenna. Therefore, the cost is reduced and the interference between two antennas is avoided.

In a preferred embodiment, the inductance of the first inductor L1 is 39 nh-100 nh. This inductance is not too low to affect the RF signal and is not too high to affect the distance sensing function. Thus, this inductance range could ensure the function of the filter module 1.

Please refer to FIG. 2 and FIG. 3 again. The RF antenna module 14 comprises an RF antenna ANT and the second resistor R2. The end of the RF antenna ANT is electrically connected to the ground through the second resistor R2 and is electrically connected to one end of the first resistor R1. The second resistor R2 is used for protection. The RF antenna module 14 could generate the resonant frequency for the distance sensing module 11 to work and could also generate the resonant frequency for the RF module 12 to work. In other words, the RF antenna module 14 could satisfy the requirement of the distance sensing signal of the distance sensing module 11 and the requirement of the RF signal of the RF module 12. The end of the RF antenna ANT has an antenna feeding point, which is electrically connected to the RF module 14 and the filter module 13 to ensure the communication signal to pass.

Please refer to FIG. 2 and FIG. 3 again. The RF module 12 comprises the RF chip U1, the third resistor R3, the fourth resistor R4 and the second capacitor C2. One end of the third resistor R3 is electrically connected to the end of the RF antenna ANT. The other end of the third resistor R3 is electrically connected to the ground through the second capacitor C2 and is also electrically connected to the signal pin of the RF chip U1 through the fourth resistor R4. The GND pin of the RF chip U1 is electrically connected to the ground. The third resistor R3 and the second capacitor C2 form the RC oscillator circuit for the filter function. The fourth resistor R4 is a protection resistor. The RF chip could be the RF chip of the model type RF1662. This model type has advantages of stable performance and great function. In another embodiment, the present invention could adopt another model type of the RF chip. This change also falls within the scope of the present invention.

When the mobile terminal is working in the communication mode, the RF antenna module 14 generates the communication signal. The RC oscillator circuit performs the filter operation on the communication signal and then transfers the filtered signal to the RF chip U1 to drive the RF chip U1 to work such that various RF functions are realized.

Please refer to FIG. 2 and FIG. 3 again. The distance sensing module 11 comprises the distance sensing chip U2, the fifth resistor R5, the sixth resistor R6, and the third capacitor C3. One end of the fifth resistor R5 is electrically connected to the other end of the first resistor R1 through the first inductor L1. The other end of the fifth resistor R5 is electrically connected to the ground through the third capacitor C3 and is electrically connected to an RX pin of the distance sensing chip U2 through the sixth resistor R6. The GND pin of the distance sensing chip U2 is electrically connected to the ground and the VDD pin of the distance sensing chip U2 is electrically connected to a 3.3V voltage source. The fifth resistor R5 and the third capacitor C3 form an RC oscillator circuit to perform the filter function. The sixth resistor R6 is the protection resistor. The distance sensing chip U2 could be the distance sensing chip of the model type LDJ18829M24AC002. This model type has advantages of stable performance and great function. In another embodiment, the present invention could adopt another model type of the distance sensing chip. This change also falls within the scope of the present invention.

When the mobile terminal is working in the communication mode, the communication signal is released to the ground through the filter module 13 and the signals having the frequency higher than 600 MHz to prevent the distance sensing function from being incorrectly triggered. When the distance sensing module needs to work, the filter module 13 could allow the low-frequency signal to pass through the filter module 13. The RC oscillator circuit performs the filter operation on the communication signal and transfers the filtered signal to the distance sensing chip U2 to drive the distance sensing chip U2 to work such that the distance sensing function is triggered.

In a further embodiment, the first resistor R1 is installed near the antenna feeding point. The first inductor L1 is installed near the distance sensing chip U2. This could ensure the filter module 13 to correctly work and prevent the interference between the devices. In this way, the distance sensing function and the RF function could be satisfied by sharing only one antenna. In addition, the layout wire is shorter on the PCB such that the influence on the RF and low frequency band is avoided.

In order to well understand the present application, a further illustration will be disclosed in the following disclosure along with FIG. 2 and FIG. 3:

The RF antenna module 14 generates the working signal when the mobile terminal is working in the communication mode. The working signal is respectively transmitted to the RF module 12 and the filter module 13. The RF module 12 receives the working signal and works accordingly. The filter module 13 receives the working signal and filters out a high frequency portion from the working signal (e.g. filter out the signal portion having the frequency higher than 600 MHz and allow the signal portion having the frequency lower than 500 MHz to pass). This prevents the distance sensing module from being incorrectly triggered. When the distance sensing module needs to work, the low frequency signal that passes through the filter module 13 could drive the distance sensing chip U2 to work such that the distance sensing function is triggered.

From the above, the mobile terminal with a shared radio frequency (RF) antenna, the mobile terminal includes a printed circuit board (PCB). A distance sensing module, a radio frequency (RF) module, and a filter module are disposed on the PCB. The distance sensing module is configured to perform a distance sensing operation. The RF module is configured to perform an RF transceiving operation. The mobile terminal of an embodiment adopts the RF antenna module and the filter module respectively capable of generating high-frequency and low-frequency resonant frequencies. Therefore, when the distance sensing module and the RF module shares the same antenna, they do not influence each other. This reduces the number of antenna and solves the issues of the above-mentioned issues of high interferences due to the short distance between two antennas and the metallic material of the two antennas. Furthermore, it also reduces the cost.

Above are embodiments of the present invention, which does not limit the scope of the present invention. Any modifications, equivalent replacements or improvements within the spirit and principles of the embodiment described above should be covered by the protected scope of the invention.

What is claimed is:

1. A mobile terminal with a shared radio frequency (RF) antenna, the mobile terminal comprising:
a printed circuit board (PCB), comprising:
a distance sensing module, configured to perform a distance sensing operation;
a radio frequency (RF) module, configured to perform an RF transceiving operation;
a filter module, configured to filter out a unwanted portion of an input signal of the distance sensing module; and
an RF antenna module, electrically connected to the RF distance sensing module through the filter module and electrically connected to the RF module, configured to generate a resonant frequency for the distance sensing module and a resonant frequency for the RF module.

2. The mobile terminal of claim 1, wherein the filter module comprises:
a first resistor;
a first capacitor; and
a first inductor;
wherein one end of the first resistor is electrically connected to the RF antenna, and another end of the first resistor is electrically connected to a ground through the first capacitor and is electrically connected to the distance sensing module through the first inductor.

3. The mobile terminal of claim 2, wherein the first inductor has an inductance between 39-100 nh.

4. The mobile terminal of claim 2, wherein the RF antenna comprises:
an RF antenna; and
a second resistor;
wherein an end of the RF antenna is electrically connected to the ground through the second resistor and is electrically connected to the end of the first resistor.

5. The mobile terminal of claim 4, wherein the RF module comprises:
an RF chip;
a third resistor;
a fourth resistor; and
a second capacitor;
wherein an end of the third resistor is electrically connected to the end of the RF antenna, another end of the third resistor is electrically connected to the ground through the second capacitor and is electrically connected to a signal pin of the RF chip through the fourth resistor, and the GND pin of the RF chip is electrically connected to the ground.

6. The mobile terminal of claim 5, wherein a model type of the RF chip is RF1662.

7. The mobile terminal of claim 2, wherein the distance sensing module comprises:
a distance sensing chip;
a fifth resistor;
a sixth resistor; and
a third capacitor;
wherein one end of the fifth resistor is electrically connected to the another end of the first resistor through the first inductor, another end of the fifth resistor is electrically connected to the ground through the third capacitor and is electrically connected to an RX pin of the distance sensing chip through the sixth resistor, a GND pin of the distance sensing chip is electrically connected to the ground, and a VDD pin of the distance sensing chip is electrically connected to a 3.3V voltage source.

8. The mobile terminal of claim 7, wherein a model type of the distance sensing chip is LDJ18829M24AC002.

9. The mobile terminal of claim 2, wherein the first resistor is installed near the antenna feeding point and the first inductor is installed near the distance sensing chip.

10. A mobile terminal with a shared radio frequency (RF) antenna, the mobile terminal comprising:
a printed circuit board (PCB), comprising:
a distance sensing module, configured to perform a distance sensing operation;
a radio frequency (RF) module, configured to perform an RF transceiving operation;
a filter module, configured to filter out a unwanted portion of an input signal of the distance sensing module; and
an RF antenna module, electrically connected to the RF distance sensing module through the filter module and electrically connected to the RF module, configured to generate a resonant frequency for the distance sensing module and a resonant frequency for the RF module;
wherein the RF antenna module generates a working signal when the mobile terminal is working in a communication mode, and the working signal is respectively transmitted to the RF module and the filter module; the RF module receives the working signal and works accordingly; and the filter module receives the working signal and filters out a high frequency portion from the working signal such that the distance sensing module and the RF module share an antenna to prevent from incorrectly triggering the distance sensing module and ensure that the distance sensing module is correctly triggered when the distance sensing operation is required.

11. The mobile terminal of claim 10, wherein the filter module comprises:
a first resistor;
a first capacitor; and
a first inductor;
wherein one end of the first resistor is electrically connected to the RF antenna, and another end of the first resistor is electrically connected to a ground through the first capacitor and is electrically connected to the distance sensing module through the first inductor.

12. The mobile terminal of claim 11, wherein the first inductor has an inductance between 39-100 nh.

13. The mobile terminal of claim 11, wherein the RF antenna comprises:
an RF antenna; and
a second resistor;
wherein an end of the RF antenna is electrically connected to the ground through the second resistor and is electrically connected to the end of the first resistor.

14. The mobile terminal of claim 13, wherein the RF module comprises:
an RF chip;
a third resistor;
a fourth resistor; and
a second capacitor;
wherein an end of the third resistor is electrically connected to the end of the RF antenna, another end of the third resistor is electrically connected to the ground through the second capacitor and is electrically connected to a signal pin of the RF chip through the fourth resistor, and the GND pin of the RF chip is electrically connected to the ground.

15. The mobile terminal of claim 14, wherein a model type of the RF chip is RF1662.

16. The mobile terminal of claim 11, wherein the distance sensing module comprises:
a distance sensing chip;
a fifth resistor;
a sixth resistor; and
a third capacitor;
wherein one end of the fifth resistor is electrically connected to the another end of the first resistor through the first inductor, another end of the fifth resistor is electrically connected to the ground through the third capacitor and is electrically connected to an RX pin of the distance sensing chip through the sixth resistor, a GND pin of the distance sensing chip is electrically connected to the ground, and a VDD pin of the distance sensing chip is electrically connected to a 3.3V voltage source.

17. The mobile terminal of claim 16, wherein a model type of the distance sensing chip is LDJ18829M24AC002.

18. The mobile terminal of claim 13, wherein an antenna feeding point is at the end of the RF antenna.

19. The mobile terminal of claim 18, wherein the first resistor is installed near the antenna feeding point and the first inductor is installed near the distance sensing chip.

20. The mobile terminal of claim 11, wherein the first capacitor is a filter capacitor for filtering out a signal portion having a frequency higher than 600 MHz.
